(19) United States
(12) Patent Application Publication
(10) Pub. No.: US 2005/0199106 A1
(43) Pub. Date: Sep. 15, 2005

(54) WRENCH, ADJUSTABLE WITH LOCKING PIN

(76) Inventor: John Tedrick, Tulsa, OK (US)

Correspondence Address: John Tedrick, 4937 S. 86th E. Avenue, Tulsa, OK, 74145, US

(21) Appl. No.: 10/795,855

(22) Filed: Mar. 9, 2004

(51) Int. Cl. B25B 13/16

(52) U.S. Cl. 81/170

(57) ABSTRACT

Adjustable wrenches have been in use for more than 100 years. They have been “slipping out of adjustment” for the same time frame. Many solutions to this problem have been proposed, some have been patented. This is my offering.

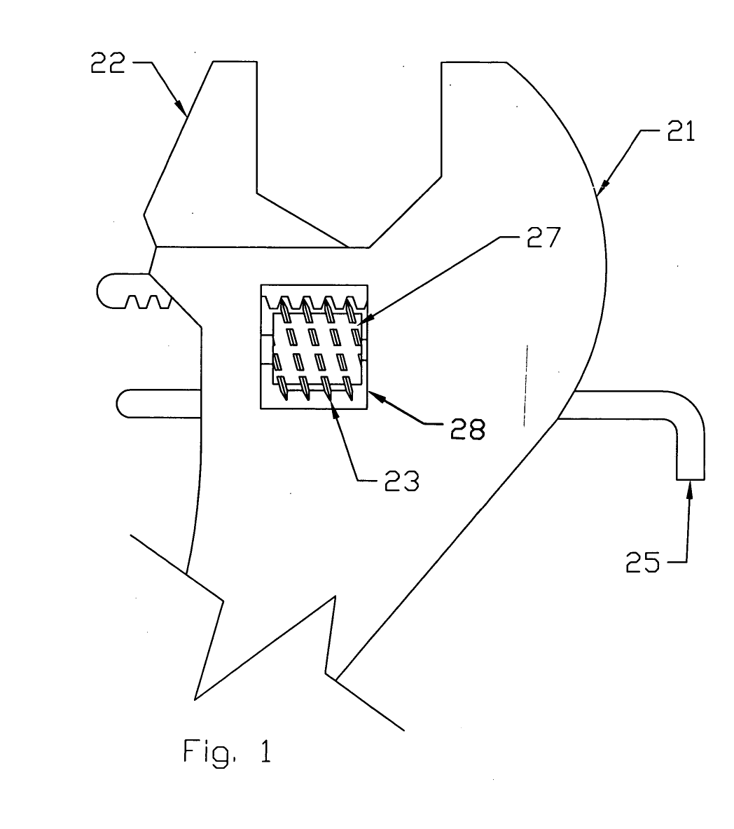

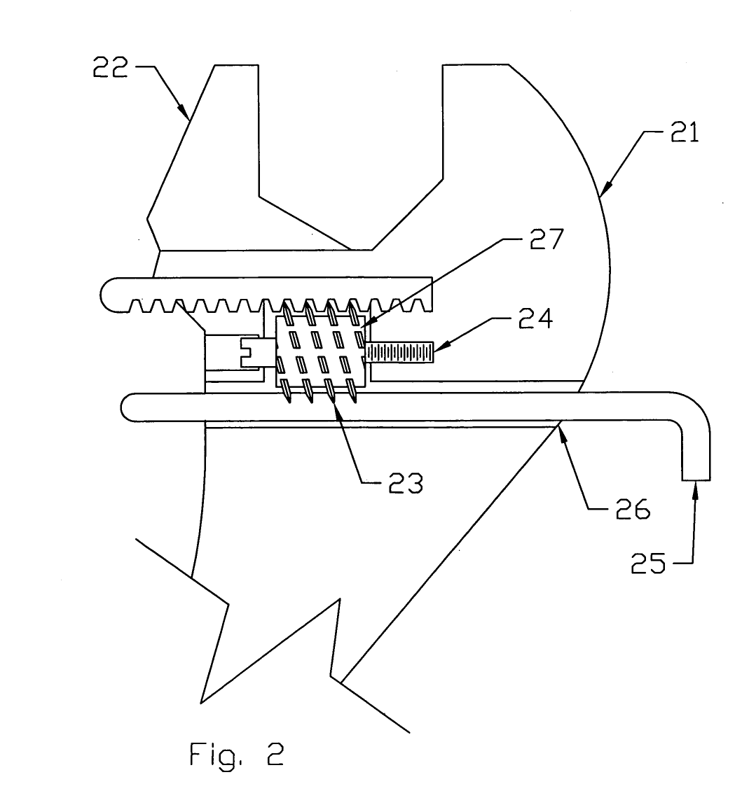

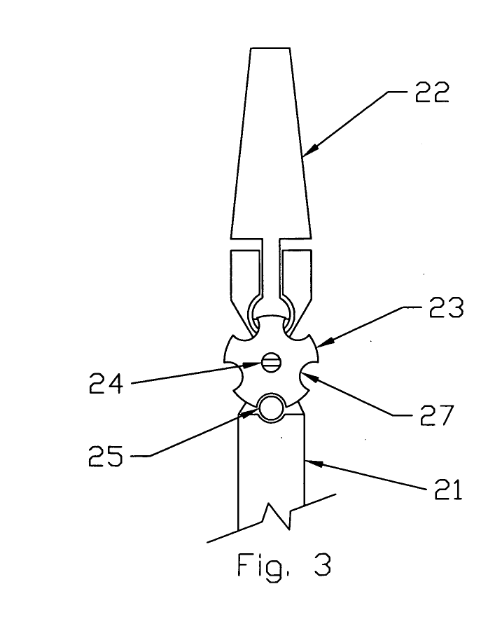

### BACKGROUND OF THE INVENTION

1. Field of the Invention

This invention relates in general to a wrench, and in particular, to a parallel, slidable jaw wrench used to tighten or loosen nuts, bolts, valve steams, or items requiring turning. Adjustable wrenches have been used for many years and are still in use today. Most mechanics, machinist, millwrights, plumbers, and electricians have this wrench in their tool box.

The wrench in its present configuration is entirely suitable for casual use.. However, for extended use, doing a job repeatedly, a device for locking the adjustment would be desirable.

2. Description of Related Art

While making a patent search I have found a number of adjustable wrench patents with some form of locking device. Such as;

Keller U.S. Pat. No. 1,444,793, Swanstrom U.S. Pat. No. 2,849,908, Lindgran U.S. Pat. No. 3,857,308, Spector U.S. Pat. No. 5,222,419, Haskell U.S. Pat. No. 5,540,125, Gustafson U.S. Pat. No. 5,644,957.

None of these inventors use a locking method such as I have shown in this invention.

### DESCRIPTION OF THE DRAWINGS

FIG. (1) is a plan view of the wrench showing the moveable jaw in the open position. The locking pin is shown in the inserted position.

FIG. (2) is a cross sectional view of the wrench showing the pin in the locking position.

FIG. (3) is an end view of the wrench showing the array of notches in the worm cooperating with the locking pin.

### DESCRIPTION OF THE INVENTION

An adjustable wrench comprising a body having a handle, a fixed jaw (21), a moveable jaw (22) having a guiding flange and rack gear, a bore having a slot to accept the moveable jaw, a window (28) to accept a rotable worm (23), a bore to accept a worm shaft (24), a bore (26) to accept a locking pin (25), a rotable worm having threads to mate with said moveable jaw rack gear, a locking pin, said worm being held in said window by said worm shaft in worm shaft bore, and mating with said moveable jaw rack gear, said worm having one or more arrays of notches (27) milled across the circumference, said locking pin mating with one of said arrays of notches and aligning and entering said locking pin bore.

1. An anti-drift improvement for an adjustable wrench having a movable jaw with a rack gear driven by a worm gear, the improvement comprising: a bore into a body of the wrench parallel to a shaft of the worm gear with a chordal portion overlapping teeth of the gear, said teeth having an array of notches extending parallel to said bore, a pin reciprocally slidable in said bore when said bore is aligned with one of said arrays of notches whereby, when inserted, said pin cooperates with said bore and one of said array of notches to prevent rotation of said worm gear.
